(19) United States
(12) Patent Application Publication
(10) Pub. No.: US 2025/0252677 A1
(43) Pub. Date: Aug. 7, 2025

(54) METHOD FOR IMPROVING PASS-THROUGH VIEW AND HOST

(71) Applicant: HTC Corporation, Taoyuan City (TW)

(72) Inventors: Jo-Han Hsu, Taoyuan City (TW); Tun-Hao Chao, Taoyuan City (TW)

(73) Assignee: HTC Corporation, Taoyuan City (TW)

(21) Appl. No.: 18/916,762

(22) Filed: Oct. 16, 2024

Related U.S. Application Data
(60) Provisional application No. 63/627,804, filed on Feb. 1, 2024.

(51) Int. Cl. G06T 19/00; G06T 7/70; G06T 15/04

(52) U.S. Cl. CPC G06T 19/006; G06T 7/70; G06T 15/04

(57) ABSTRACT

The embodiments of the disclosure provide a method for improving a pass-through view and a host. The method includes: obtaining current per-frame information and historical per-frame information of the host; determining historical tracking information and texture information of a target object based on the historical per-frame information of the host; predicting current tracking information of the target object based on the historical tracking information of the target object and the current per-frame information of the host; rendering an object image corresponding to the target object based on the current tracking information and the texture information of the target object; and generating the pass-through view based on the rendered object image, the current per-frame information of the host, and the current tracking information of the target object, and displaying the pass-through view.

### CROSS-REFERENCE TO RELATED APPLICATION

This application claims the priority benefit of U.S. provisional application Ser. No. 63/627,804, filed on Feb. 1, 2024. The entirety of the foregoing patent application is hereby incorporated by reference herein and made a part of this specification.

### BACKGROUND

### Technical Field

The disclosure relates to a mechanism for providing reality services, and in particular relates to a method for improving a pass-through view and a host.

### Description of Related Art

Mixed Reality (MR) is a technology that combines the real world with the virtual world, allowing virtual objects to interact and integrate with objects in the real environment and enabling users to see and control content from both of the worlds at the same time.

The main features of MR include blending reality and virtuality, superimposing virtual objects (such as 3D models and holographic images) in the real world, and dynamically adjusting according to a user's position and viewing angle. Moreover, users may interact with virtual objects, and the objects will perform corresponding reactions based on the real-world environment and the users' actions. Through head-mounted displays (HMD) or other devices, users are allowed to experience an immersive experience that seamlessly integrates virtual and real content.

When a MR service is provided, the HMD may present corresponding visual content to a user for viewing, and the visual content may include a pass-through view and virtual objects superimposed on the pass-through view. The foregoing pass-through view may be generated by the HMD based on image frames (which may include a real-world scene in front of the HMD) captured by a front camera thereof (e.g., the commonly known RGB camera).

Generally speaking, after the HMD obtains the image frames captured by front camera, projections based on the position of the user's eyes are required to generate left-eye image frames corresponding to the user's eyes (may be understood as a pass-through view corresponding to the left eye) and right-eye image frames (may be understood as a pass-through view corresponding to the right eye). After that, the left-eye image frames and the right-eye image frames are respectively displayed to the user's left eye and right eye by the near-eye display respectively corresponding to the user's eyes.

However, since the position of the front camera on the HMD is not the same as the position of the user's eyes, if the texture of an object in front of the user cannot be captured by the front camera, a problem of missing texture may occur in the pass-through view generated through the HMD projection.

For ease of understanding, FIG. 1 will be taken as an example. See FIG. 1, which is a schematic diagram of missing texture. In the scenario of FIG. 1, the front camera of the HMD is assumed to be disposed at the position of the user's right eye. Therefore, when the user makes a gesture shown in FIG. 1 with the right hand (such as a hand-knife gesture with the palm facing left) and places the right hand in front of the right eye, the user's left eye and right eye ideally should respectively see a left-eye image frame 101 and a right-eye image frame 102. Furthermore, since there is a viewing angle difference between the user's eyes, when the user places the gesture shown in front of the right eye, the user's left eye ideally should be able to see the texture on the user's right palm.

However, limited by the position of the front camera, when the user places the shown right hand gesture in front of the right eye, the front camera cannot actually capture the palm of the user's right hand. In this case, the image frames generated by the HMD based on the image frames captured by the front camera would be, for example, a left-eye image frame 111 and a right-eye image frame 112. It may be seen from the left-eye image frame 111 that in the foregoing scenario, the user's left eye is not able to correctly see the texture of the right palm in the left-eye image frame 111 (that is, there is a problem of missing texture on the right palm). In this case, the user's visual experience will be affected.

### SUMMARY

In view of this, the disclosure provides a method for improving a pass-through view and a host that may be configured to solve the foregoing technical problem.

According to the embodiment of the disclosure, a method for improving a pass-through view is provided that is executed by a host that provides a mixed reality service. The method includes: current per-frame information and historical per-frame information of the host are obtained; historical tracking information and texture information of a target object are determined based on the historical per-frame information of the host; current tracking information of the target object is predicted based on the historical tracking information of the target object and the current per-frame information of the host; an object image corresponding to the target object is rendered based on the current tracking information and the texture information of the target object; and the pass-through view is generated based on the rendered object image, the current per-frame information of the host, and the current tracking information of the target object, and the pass-through view is displayed.

According to the embodiment of the disclosure, a host that provides a mixed reality service is provided, including a front camera, a storage circuit and a processor. The storage circuit stores a program code. The processor is coupled to the front camera and the storage circuit and accesses the program code to execute: current per-frame information and historical per-frame information of the host are obtained; historical tracking information and texture information of the target object are determined based on the historical per-frame information of the host; current tracking information of the target object is predicted based on the historical tracking information of the target object and the current per-frame information of the host; an object image corresponding to the target object is rendered based on the current tracking information and the texture information of the target object; and a pass-through view is generated based on the rendered object image, the current per-frame information of the host, and the current tracking information of the target object, and the pass-through view is displayed.

### BRIEF DESCRIPTION OF THE DRAWINGS

FIG. 1 is a schematic diagram of missing texture.

FIG. 2 is a schematic diagram of a host according to an embodiment of the disclosure.

FIG. 3 is a flowchart of a method for improving a pass-through view according to an embodiment of the disclosure.

FIG. 4 is an application scenario diagram according to an embodiment of the disclosure.

### DESCRIPTION OF THE EMBODIMENTS

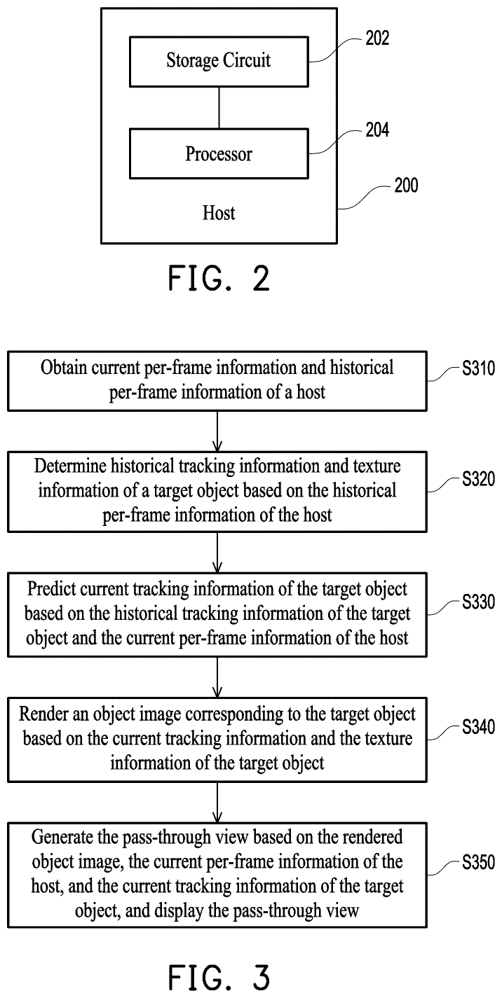

See FIG. 2, which shows a schematic diagram of a host according to an embodiment of the disclosure. In various embodiments, a host 200 may be any device capable of executing tracking functions (such as inside-out tracking and/or outside-in tracking) on one or multiple target objects (also called to-be-tracked objects, trackable objects, etc., such as a hand of a user of the host 200) within a tracking range of the host 200. In the embodiment of the disclosure, the host 200 may be provided with a tracking camera whose image capture range corresponds to a tracking range. When a target object (such as a hand) is within the tracking range, the tracking camera on the host 200 may capture an image of the target object, and the host 200 may track poses of each target object based on the captured images, but the disclosure is not limited thereto.

In various embodiments, the host 200 may be any smart device and/or computer device capable of providing visual content of a reality service, such as a virtual reality (VR) service, an augmented reality (AR) service, a mixed reality (MR) service and/or an extended reality (XR) service, but the disclosure is not limited thereto. In some embodiments, the host 200 may be a head-mounted display (HMD) capable of displaying/providing visual content (such as AR/VR/MR content) for the wearer/user to watch. In order to better understand the concept of the disclosure, it is assumed that the host 200 is an MR device (e.g., an MR HMD) configured to provide MR content for users to watch, but the disclosure is not limited thereto.

In an embodiment where the visual content is an MR content, the MR content may include a pass-through view. In an embodiment, the MR content may further include at least one rendered virtual object overlaid/superimposed on the pass-through view. In this case, the pass-through view is used as an underlying image of the visual content, but the disclosure is not limited thereto.

In an embodiment, the pass-through view may be rendered, for example, by a processor 204 of the host 200 based on, for example, image frames (such as RGB image frames) captured by a front camera (such as RGB camera) of the host 200. In this case, the user wearing the host 200 (such as HMD) may see the real-world scene in front of the user through the pass-through view in the visual content provided by the host 200.

In an embodiment, the processor 204 may render one or multiple virtual objects based on an MR application currently running on the host 200. The processor 204 may overlay the rendered virtual objects on a rendered pass-through view to form/generate visual content (such as MR content).

In an embodiment, the host 200 may be provided with a built-in display (such as the near-eye displays corresponding to the user's eyes) to display visual content for the user to watch. Additionally or alternatively, the host 200 may be connected to one or multiple external displays, and the host 200 may transmit visual content to the external display for displaying the visual content, but the disclosure is not limited thereto.

In FIG. 2, the host 200 includes a storage circuit 202 and the processor 204. The storage circuit 202 is a combination of one or multiple static or dynamic random-access memory (RAM), read only memory (ROM), flash memory, hard disk or any other similar devices, that records multiple modules that may be executed by the processor 204.

The processor 204 may be coupled to the storage circuit 202. The processor 204 may be, for example, a general purpose processor, a special purpose processor, a conventional processor, a digital signal processor (DSP), multiple microprocessors, one or multiple microprocessors associated with a DSP core, a controller, a microcontroller, application specific integrated circuits (ASICs), field programmable gate arrays (FPGAs) circuits, any other type of integrated circuits (IC), a state machine, a graphic processing unit (GPU), etc.

In the embodiment of the disclosure, the processor 204 may access modules and/or program codes stored in the storage circuit 202 to implement the method for improving a pass-through view provided in the disclosure. Detailed discussions would be provided in the following.

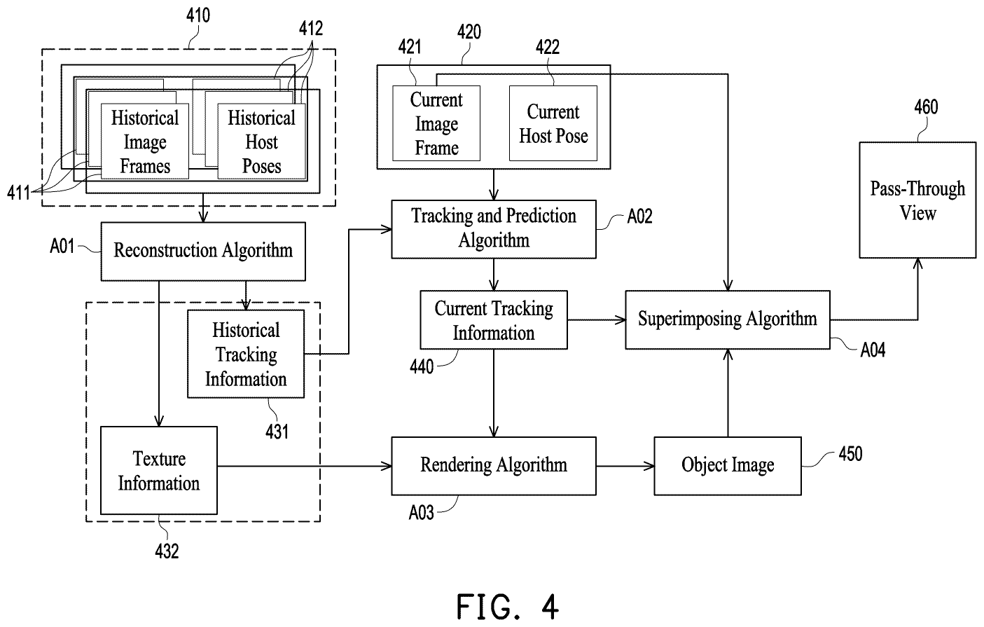

See FIG. 3, which shows a flowchart of a method for improving a pass-through view according to an embodiment of the disclosure. The method in the embodiment may be executed by the host 200 in FIG. 2. Details of each step in FIG. 3 will be described in accompanying with the elements shown in FIG. 2. In addition, in order to make the concept of the disclosure easier to understand, FIG. 4 will be used as an example for description below, wherein FIG. 4 shows an application scenario diagram according to an embodiment of the disclosure.

In step S310, the processor 204 obtains current per-frame information 420 and historical per-frame information 410 of the host 200.

In the embodiment of the disclosure, the current per-frame information 420 may be, for example, used by the host 200 to accordingly render MR visual content corresponding to the state/scenario at the current time point, but the disclosure is not limited thereto.

In FIG. 4, the current per-frame information 420 includes, for example, a current image frame 421 and a current host pose 422. In an embodiment, the current image frame 421 is, for example, an image frame captured by front camera of the host 200 of the real-world scene currently in front of the host 200, but the disclosure is not limited thereto.

In addition, the current host pose 422 is, for example, data obtained by the host 200 tracking the current pose of the host 200 itself based on the used inside-out tracking mechanism and/or outside-in tracking mechanism. In some embodiments, the current host pose 422 may be, for example, presented in a form of six-degree-of-freedom, but the disclosure is not limited thereto.

In some embodiments, the current per-frame information 420 may further include other information, such as intrinsic parameters and extrinsic parameters of the tracking camera. In addition, the current per-frame information 420 may further include intrinsic parameters and extrinsic parameters of an inertial measurement unit (IMU) of the host 200.

In the embodiment of the disclosure, the historical per-frame information 410 is, for example, the information that used by the host 200 to render the MR visual content corresponding to the state/scenario of a historical time point in the past, but the disclosure is not limited thereto.

In FIG. 4, the historical per-frame information 410 includes, for example, historical image frames 411 and historical host poses 412. In an embodiment, the historical image frames 411 are, for example, image frames previously captured by the front camera of the host 200 of the real-world scene previously in front of the host 200, but the disclosure is not limited thereto.

In addition, the historical host poses 412 are, for example, data obtained by the host 200 previously tracking the poses of the host 200 itself. In some embodiments, the historical host poses 412 may be, for example, presented in a form of six-degree-of-freedom, but the disclosure is not limited thereto.

In an embodiment, assuming that the current per-frame information 420 is the per-frame information obtained by the host 200 at an i-th time point (i is a time index value), the historical per-frame information 410 may be understood as the per-frame information that was obtained by the host 200 at other time points before the i-th time point.

For example, the current per-frame information 420 may, for example, include an image frame captured by the front camera of the host 200 at the i-th time point (which may be referred to as the current image frame 421), and a host pose tracked by the host 200 at the i-th time point (which may be referred to as the current host pose 422). In this case, the historical per-frame information 410 may include image frames (which may be collectively referred to as the historical image frames 411) captured by the front camera of the host 200 from an (i−1)th time point to an (i−K)th time point (K may be a positive integer determined by the designer), and the host poses (which may be collectively referred to as the historical host poses 412) individually tracked by the host 200 from the i−1th time point to the (i−K)th time point.

In step S320, the processor 204 determines historical tracking information 431 and texture information 432 of the target object (referred to as O hereinafter) based on the historical per-frame information 410 of the host 200.

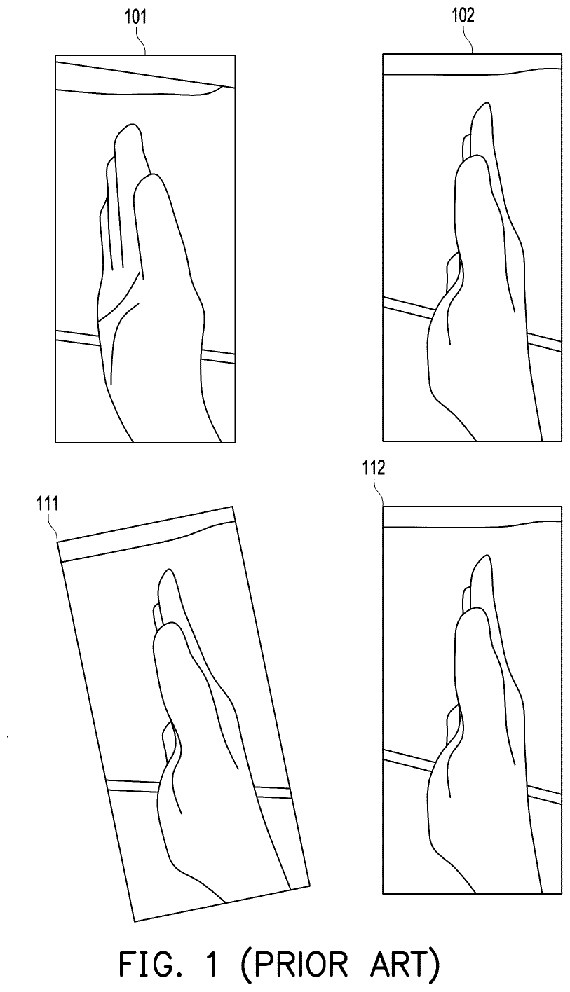

For ease of understanding, it is assumed below that the considered target object O is the user's hand (such as the user's right hand in the scenario of FIG. 1). In other embodiments, the considered target object O may be adjusted to be various objects that is trackable to the host 200 according to the designer's requirements, such as a handheld controller, various trackers, trackable furniture or furnishings, etc., but the disclosure is not limited thereto.

In FIG. 4, the processor 204 may, for example, execute a reconstruction algorithm A01 based on the historical image frames 411 and the corresponding historical host poses 412 to determine the historical tracking information 431 and the texture information 432 of the target object O.

In the embodiment of the disclosure, when obtaining each image frame and the corresponding host pose, the processor 204 that applies the reconstruction algorithm A01 may generate a corresponding point cloud through 2D to 3D un-projection. After accumulating point clouds of multiple frames (e.g., historical image frames 411), the processor 204 may further combine kinematic models of various objects collected in advance to optimize and predict a point cloud correspondence, and improve the results of kinematic models accordingly.

Through combining the point cloud correspondence of multiple frames and RGB images, a mesh model of the target object O (and/or other trackable objects) with texture may be simplified and optimized. The mesh model may be used as the texture information 432 in FIG. 4. After that, the processor 204 may further utilize the optimized kinematic model results to analyze/determine the precise tracking information of the target object O (and/or other trackable objects), and then determine the historical tracking information 431 of the target object O.

In different embodiments, the reconstruction algorithm A01 may be, for example, implemented using technical means such as Multi-View Stereo, Truncated Signed Distance Function fusion, Neural Radiance Fields or the like, but the disclosure is not limited thereto.

In step S330, the processor 204 predicts current tracking information 440 of the target object O (such as current pose of the target object O) based on the historical tracking information 431 of the target object O and the current per-frame information 420 of the host 200.

In FIG. 4, the processor 204 may, for example, execute a tracking and prediction algorithm A02 based on the historical tracking information 431 and the current per-frame information 420 to predict the current tracking information 440 of the target object O.

In the embodiment of the disclosure, the processor 204 applying the tracking and prediction algorithm A02 may utilize some motion prediction technology to predict the current tracking information 440 of the target object O based on the historical tracking information 431 and the current per-frame information 420.

In different embodiments, the tracking and prediction algorithm A02 may, for example, be implemented using technical means such as Kalman filter, particle filter or the like, but the disclosure is not limited thereto.

In step S340, the processor 204 renders an object image 450 corresponding to the target object O based on the current tracking information 440 and the texture information 432 of the target object O.

In FIG. 4, the processor 204 may, for example, execute a rendering algorithm A03 based on the current tracking information 440 and the texture information 432 of the target object O to render the object image 450 corresponding to the target object O.

In an embodiment, the processor 204 applying the rendering algorithm A03 may, for example, use some 3D to 2D projection technology to render the object image 450 corresponding to the target object O based on the current tracking information 440 and the texture information 432 of the target object O.

In different embodiments, the rendering algorithm A03 may, for example, be implemented using technical means such as Rasterization, ray tracing or the like, but the disclosure is not limited thereto.

Since the processor 204 may render the object image 450 (such as the image of a hand) based on the texture information 432, the object image 450 may still present the corresponding texture, and hence the previously mentioned problem of missing texture can be avoided.

In an embodiment, the texture corresponding to at least a part of the rendered object image 450 does not exist in the current image frame 421. Specifically, for the front camera of the host 200, at least a part on the target object O (such as the right palm in the scenario of FIG. 1) may not be directly captured by the front camera into the current image frame 421. However, since the processor 204 renders the object image 450 based on the texture information 432, even if at least one part on the target object O is not captured in the current image frame 421, the rendered object image 450 may still correctly present the corresponding texture.

In step S350, the processor 204 generates a pass-through view 460 based on the rendered object image 450, the current per-frame information 420 of the host 200, and the current tracking information 440 of the target object O, and displays the pass-through view 460.

In FIG. 4, the processor 204 may, for example, generate the pass-through view 460 based on a superimposing algorithm A04.

In an embodiment, the processor 204 applying the superimposing algorithm A04 may determine a trackable part and a non-trackable part in the current image frame 421 based on the current image frame 421 and the current tracking information 440 of the target object O. In different embodiments, the trackable part includes, for example, various trackable objects, and the non-trackable part includes, for example, various non-trackable objects, such as background objects, etc., but the disclosure is not limited thereto.

In the embodiment of FIG. 4, the trackable part, for example, corresponds to the target object O, but the disclosure is not limited thereto.

After that, the processor 204 may execute a image-based rendering algorithm based on the non-trackable part to generate a reference frame. Details of the image-based rendering algorithm may refer to the documents related to Triangular mesh-based image warping or the like, and will not be described again here.

After generating the foregoing reference frame, the processor 204 may superimpose the rendered object image 450 on the reference frame based on the current tracking information 440 of the target object O to generate the pass-through view 460.

As mentioned in the above, since there is no problem of missing texture on the object image 450, after the processor 204 superimposes the object image 450 on the reference frame to generate the pass-through view 460, the problem of missing texture in an image region corresponding to the object image 450 within the pass-through view 460 may be avoided.

Taking FIG. 1 as an example, after applying the method proposed by the embodiment of the disclosure, the user's left eye and right eye may respectively watch the left-eye image frame 101 and the right-eye image frame 102, and the user can be prevented from having poor visual experience due to watching image frames with missing texture.

In summary, the method proposed by the embodiments of the disclosure may determine the historical tracking information and the texture information of the target object by the host based on the historical per-frame information, and render the object image based on the texture information of the target object and the current tracking information of the target object that is obtained through prediction. After that, the rendered object image may further be superimposed onto the current image frame captured by the front camera to generate the pass-through view. Since the object image is obtained through rendering based on the foregoing texture information, the problem of missing texture in the image region corresponding to the target object in the pass-through view may be avoided. In this way, the user's visual experience can be improved.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A method for improving a pass-through view, executed by a host that provides a mixed reality service, the method comprising:
obtaining current per-frame information and historical per-frame information of the host;
determining historical tracking information and texture information of a target object based on the historical per-frame information of the host;
predicting current tracking information of the target object based on the historical tracking information of the target object and the current per-frame information of the host;
rendering an object image corresponding to the target object based on the current tracking information and the texture information of the target object; and
generating the pass-through view based on the rendered object image, the current per-frame information of the host, and the current tracking information of the target object, and displaying the pass-through view.

2. The method according to claim 1, wherein determining the historical per-frame information of the host comprises a plurality of historical image frames captured by a front camera of the host and a plurality of historical host poses corresponding to the plurality of historical image frames, and the historical tracking information and the texture information of the target object based on the historical per-frame information of the host comprise:
determining the historical tracking information and the texture information of the target object that through executing a reconstruction algorithm based on the plurality of historical image frames and the corresponding plurality of historical host poses.

3. The method according to claim 1, wherein the current per-frame information of the host comprises a current image frame captured by a front camera of the host and a current host pose corresponding to the current image frame.

4. The method according to claim 3, wherein generating the pass-through view based on the rendered object image, the current per-frame information of the host and the current tracking information of the target object comprises:
determining a trackable part and a non-trackable part in the current image frame based on the current image frame and the current tracking information of the target object, wherein the trackable part corresponds to the target object;
generating a reference frame by executing a constant depth rendering algorithm based on the non-trackable part; and
generating the pass-through view by superimposing the rendered object image on the reference frame based on the current tracking information of the target object.

5. The method according to claim 3, wherein a texture corresponding to at least a part of the rendered object image does not exist in the current image frame.

6. A host that provides a mixed reality service, comprising:
a non-transitory storage circuit, storing a program code; and
a processor, coupled to the storage circuit and configured to access the program code to execute:
obtaining current per-frame information and historical per-frame information of the host;
determining historical tracking information and texture information of a target object based on the historical per-frame information of the host;
predicting current tracking information of the target object based on the historical tracking information of the target object and the current per-frame information of the host;
rendering an object image corresponding to the target object based on the current tracking information and the texture information of the target object; and
generating a pass-through view based on the rendered object image, the current per-frame information of the host, and the current tracking information of the target object, and displaying the pass-through view.

7. The host according to claim 6, wherein the historical per-frame information of the host comprises a plurality of historical image frames captured by a front camera of the host and a plurality of historical host poses corresponding to the plurality of historical image frames, and the processor is configured to execute:
determining the historical tracking information and the texture information of the target object through executing a reconstruction algorithm based on the plurality of historical image frames and the corresponding plurality of historical host poses.

8. The host according to claim 6, wherein the current per-frame information of the host comprises a current image frame captured by a front camera of the host and a current host pose corresponding to the current image frame.

9. The host according to claim 8, wherein the processor is configured to execute:
determining a trackable part and a non-trackable part in the current image frame based on the current image frame and the current tracking information of the target object, wherein the trackable part corresponds to the target object;
generating a reference frame by executing a constant depth rendering algorithm based on the non-trackable part; and
generating the pass-through view by superimposing the rendered object image on the reference frame based on the current tracking information of the target object.

10. The host according to claim 8, wherein a texture corresponding to at least a part of the rendered object image does not exist in the current image frame.
